(19) United States
(12) Patent Application Publication
(10) Pub. No.: US 2002/0126990 A1
(43) Pub. Date: Sep. 12, 2002

(54) Creating on content enhancements

(76) Inventors: Gary Rasmussen, Parker, CO (US); Steven O. Markel, Highlands Ranch, CO (US); Ian Zenoni, Highlands Ranch, CO (US); Steven Reynolds, Littleton, CO (US); Thomas Huber, Parker, CO (US)

Correspondence Address: The Law Office of William W. Cochran, LLC, Suite 230, 3555 Stanford Road, Fort Collins, CO, 80525, US

(21) Appl. No.: 10/041,881

(22) Filed: Oct. 24, 2001

Related U.S. Application Data
(60) Provisional application No. 60/243,107, filed on Oct. 24, 2000.
(60) Provisional application No. 60/309,714, filed on Aug. 2, 2001.

(51) Int. Cl. H04N 5/91

(52) U.S. Cl. 386/68

(57) ABSTRACT

A video stream may be edited such that hot spots and their attributes may be added to the video stream. Hot spots and their attributes may be stored in a generic database. A translator may generate the hot spot information in a specific code for a specific application, such as properly formatted for a specific set top box hardware configuration, a specific language, or a specific look and feel of the hot spots. Additionally, a template may be used to define selected parameters of the hot spots, and the template may be changed such that the translator can create enhanced video streams in several different formats based on the templates.

### CROSS REFERENCE TO RELATED APPLICATIONS

This application is based upon and claims priority to United States provisional application 60/243,107 entitled “CREATING ‘ON-CONTENT’ ENHANCEMENTS” filed Oct. 24, 2000 by Gary Rasmussen, Steven O. Markel, Ian Zenoni, Steven Reynolds, and Thomas Huber, United States provisional application serial No. 60/309,714 entitled “POST PRODUCTION VISUAL ALTERATIONS” filed Aug. 2, 2001 by Thomas Lemmons, and U.S. non-provisional application 09/935,492 entitled “SYSTEM AND METHOD FOR WEB BASED ENHANCED INTERACTIVE TELEVISION CONTENT PAGE LAYOUT” filed Aug. 21, 2001 by Steven O. Markel. The entire disclosure of each of these applications is additionally specifically incorporated herein by reference for all that they disclose and teach.

### BACKGROUND OF THE INVENTION

a. Field of the Invention

The present invention pertains generally to interactive television and specifically to interactive enhancements that are located on the video image.

b. Description of the Background

In the prior art, a viewer subscribing to enhanced content video and choosing to view enhanced and interactive television content typically will see the standard video presentation shrunk down to ⅔ size and have the remainder of the screen available for the enhancements. Such enhancements may be buttons that the viewer may select to display additional content, advertisements and offers for sale for various products, textual or graphical displays that augment the main video program, or other interactive content.

The shrinking of the video presentation has several detrimental effects on the viewer. The viewer does not fully enjoy the video presentation since the size of the screen is minimized. The viewer's eyes, rather than being fixated on the video presentation, may be distracted by the interactive content. The interactive content may change during the video presentation, which further distracts the viewer.

It would be valuable to provide an interactive access point, i.e., an on content enhancement point such as a ‘hot spot’ and a system and method for generating a hot spot that is both easy to use and can be located on the streaming content.

### SUMMARY OF THE INVENTION

The present invention overcomes the disadvantages and limitations of the prior art by providing a simple and easy to use application that can quickly create a hot spot on a video image. Further, the present invention allows an author to create hot spot definitions that may be translated into several different formats for final viewing.

The present invention may therefore comprise a method of creating links to enhanced content on a video stream comprising the steps of: enabling a user to halt the video stream so at to provide a single video frame or “screenshot” for viewing; overlaying a portion of the screenshot with a geometric outline to identify a hot spot on the screenshot; assigning enhancement attributes to the hot spot; storing the hot spot and the attributes in a generic format; translating the hot spot and the attributes from the generic format into a first format; and embedding the hot spot and the attributes in the first format into a video stream.

The present invention may further comprise a method of creating links to enhanced content on a video stream using a template comprising the steps of: creating a template that defines at least one attribute for a hot spot; enabling a user to halt the video stream so at to provide a single video frame or “screenshot” for viewing; overlaying a portion of the screenshot with a geometric outline to identify a hot spot on the screenshot; assigning at least one attribute to the hot spot based on the template; and embedding the hot spot and the attributes in the specific format into a video stream.

The present invention may further comprise a method of creating customized links to enhanced content on a video stream using a template comprising the steps of: creating a template that defines at least one attribute for a hot spot; enabling a user to halt said video stream so at to provide a single video frame or “screenshot” for viewing; overlaying a portion of the screenshot with a geometric outline to identify a hot spot on the screenshot; assigning at least one attribute to the hot spot based on the template; storing the hot spot and the attributes in a generic format; translating the hot spot and the attributes from the generic format into a first format, said translating being done with the template; and embedding the hot spot and the attributes in the first format into a video stream.

The present invention may further comprise a method of linking and using enhanced content on a video stream comprising the steps of: enabling a user to halt the video stream so at to provide a single video frame or “screenshot” for viewing; overlaying a portion of the screenshot with a geometric outline to identify a hot spot on the screenshot; assigning enhancement attributes to the hot spot; storing the hot spot and the attributes in a generic format; translating the hot spot and the attributes from the generic format into a first format; embedding the hot spot and the attributes in the first format into a video stream; displaying the hot spot using a first set top box on a video screen; and allowing a viewer to access the hot spot whereby the viewer may access the enhanced content.

The advantages of the present invention are that the enhancements may be reused for several applications without redoing an extensive amount of work. The enhancements may be formatted for different hardware platforms, different languages, and a different look and feel without any manual editing of the actual hot spots. Further, the use of predefined formats allows the author to create consistent looking enhancements quickly and easily.

### BRIEF DESCRIPTION OF THE DRAWINGS

In the drawings,

FIG. 1 is an illustration of a television screen showing a news clip.

FIG. 2 is an illustration of the news clip of FIG. 1 with hot spots overlaid thereupon.

FIG. 3 is a work flow diagram of an embodiment of the present invention wherein a person may create on-content enhancements to a video signal.

FIG. 4 is a flow chart of the overall sequence of an embodiment of the present invention.

FIG. 5 is a flow chart of the hot spot creation sequence of the embodiment of FIG. 4.

FIG. 6 is a flow chart of the preview sequence of the embodiment of FIG. 4.

FIG. 7 is a flow chart of the publication sequence of the embodiment of FIG. 4.

FIG. 8 illustrates a block diagram of a set top box.

### DETAILED DESCRIPTION OF THE INVENTION

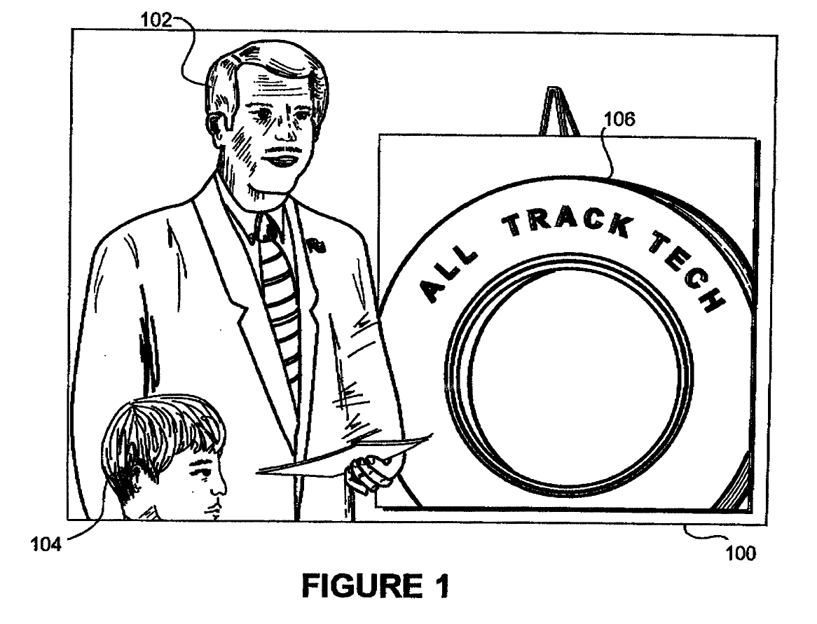

FIG. 1 illustrates a video image 100 depicting a television news clip. The news clip is depicting a press conference announcing a tire recall, with one gentleman 102 speaking at a podium, another gentleman 104 seated, and a picture of a tire 106 on an easel. The image is a news feed from a camera at a press conference and is typical of the images used in national nightly news programs.

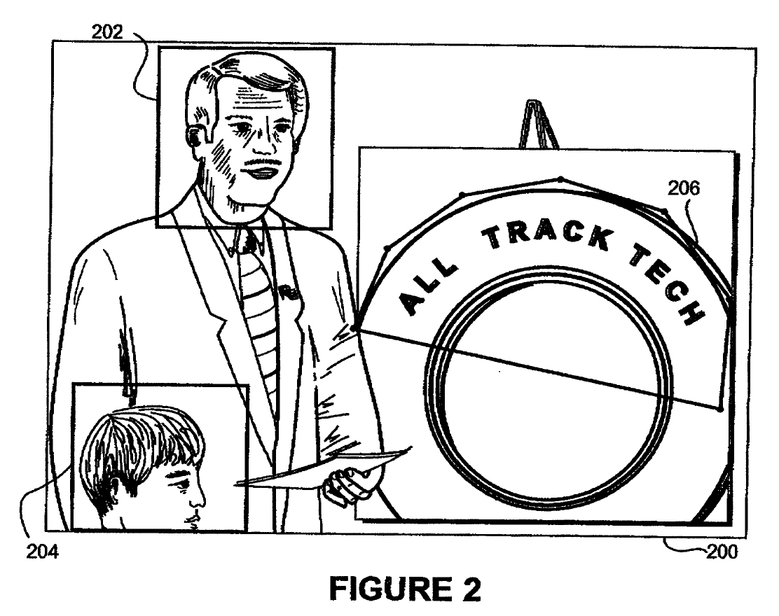

FIG. 2 illustrates a video image 200, which is the image of FIG. 1 with hot spots overlaid thereupon. The gentleman speaking at the podium is defined with hot spot 202, the seated gentleman is defined by hot spot 204, and the tire is defined by hot spot 206.

Hot spots may be embedded commands in the video broadcast that are read by a set top box, which may take the commands, create the hot spot, display the hot spot overlaid on the video signal, accept input from the user, and transmit data to a remote sever.

The hot spots 202, 204, and 206 may be geometric shapes that are placed over the streaming media. Hot spots 202 and 204 are shown as rectangular outlines that identify the two persons. Hot spot 206 is a hot spot defined by an eight-sided polygon. Hot spots 202 and 204 define areas that each include a head of a gentleman in the picture, but do not closely map the gentlemen's profiles. Hot spot 206 closely, but not exactly, matches the outline of the tire. The hot spots need only be precise enough to help the user determine what object or portion of the screen is related to the interactive content. For example, hot spot 202 may be linked to a short biography of the gentleman.

In other embodiments, hot spots may be shaped to closely follow the contour of a particular person or object in a video presentation. Such an embodiment may be particularly useful if many hot spots were to be presented. In yet another embodiment, a hot spot may be constructed to cover the entire display. Further, a hot spot may be constructed to include the entire screen and then other hot spots may be constructed over only certain areas of the screen.

Hot spots may be substantially larger than the items that the hot spots track. For example, the hot spot 202 refers to the standing gentleman's head, but the hot spot is almost 100% larger in area than the gentleman's head. In some cases, such as where the item is very small on the screen, a hot spot may be several times larger than the area of the item to which it refers. In other cases, the hot spot may be a single icon or spot of a significant color. When the viewer moves a cursor near the spot, the hot spot may become active.

The viewer may select a hot spot by moving a cursor over the hot spot and selecting the hot spot. The cursor may be moved with a keypad, mouse, joystick, gyroscopic pointing device, or other device adapted to move a cursor on a television screen. In some cases, the hot spots may be selected by tabbing through the hot spots with a single key. As the hot spot is selected, an action associated with the hot spot may be performed. The selection of the hot spot may be to have the viewer press a button, issue a verbal or audible command such as speaking or clapping, or otherwise provide input to activate the hot spot. In some instances, merely placing the cursor on the hot spot may cause an action, such as illuminating the hot spot or providing a text descriptor for the hot spot. In other instances, selecting the hot spot may display a menu of choices for the actions associated with the hot spot.

In some embodiments, the outline of the hot spot areas may be visible to the viewer. The hot spot borders may be different colors or have different visual and graphical features. The colors of each border may correspond with a button on an input device, such as a remote control or keyboard, or may be used to indicate certain parameters regarding the interactive content. Other features, such as a border around the hot spot, the thickness of the border, a blinking, pulsating, or change in intensity of the border, a graying out of the actual object defined by the hot spot, or other visual cues may be used to further indicate certain parameters. Additionally, icons or other graphical elements may be used to indicate certain parameters. Such parameters may be the action associated with the hot spot, the type of content associated with the hot spot, the length or detail of the interactive content, whether the item highlighted is offered for sale or a special promotion is offered for that item, the importance of the content with respect to the story, the length of time that the hot spot will remain active, the source of the interactive content, or other parameters as may be desired.

For example, a hot spot with a small text icon may cause a small window to be created over a portion of the display and display a short biography of a person, or a hot spot with a camera icon cause a replay of a scene that was shown previously. In another example, a red hot spot may cause the audio track to mute and have another audio clip played. In another example, a hot spot with a flashing border may cause data to be sent back to a server for aggregation, such as a vote to be tallied for or against a certain participant in a game show. In another example, a green hot spot may cause a product purchase to be initiated. In another example, a grayed out hot spot may cause a text description of an object to be sent to the display on the person's remote control via infrared or wireless link. In yet another example, a hot spot with an email icon may cause an email coupon, description, or a special promotional web link to be sent to the viewer's email address.

In some embodiments, the hot spots may be tailored to an individual's buying habits and interests. For example, hot spots may be available to a viewer whose preference for alcoholic beverages is known and not made available to a viewer who's distaste for alcohol is also known. The choice of the availability of hot spots may be done by the viewer himself or by the distributor of the interactive media. For example, an advertiser who pays for the hot spot link may only pay to target their specific audience, such as beer drinking males from 25 to 35 years of age. In this case, the distributor of the media may only make the advertiser's hot spots available to viewers in a specific demographic segment. In another embodiment, the viewer may program a set top box to allow or disallow certain hot spots. For example, a viewer may disallow hot spots relating to pornographic links or links to purchase items. The viewer may be able to use a menu system on the set top box to activate or deactivate specific interactive content. Further, the viewer may choose to pay extra to have certain interactive features activated or deactivated. For example, the viewer may pay an extra amount of money each month to have textual descriptors and reference material available through hot spots. In another example, the viewer may pay extra money to have unwanted advertisements removed from the interactive content of the shows broadcast to the viewer.

When enhanced and interactive video hot spots are available for a particular scene, a special small icon, such as the ‘Buycon TM’ image used by Intellocity USA, Inc., may appear in a corner of the screen. Clicking on the icon may momentarily present a heads up display (HUD) that draws a border around each hot spot in the scene. Along with the borders, the HUD could also display a brief product or advertising information.

One aspect of the present invention is directed to providing the viewer with information. Suppose that the viewer was watching the program of a tire recall depicted in FIG. 2. If the viewer clicked on the hot spot 206 located on the tire, a small window may be presented that may detail which cars had this tire factory installed, where to get the tire replaced, and an email or web address for more information. The hot spot 206 may also have the information necessary to transmit data to handheld receiving devices. Each device may display the information, such as news, pricing, etc. In such an embodiment, several people in a household, each watching the same program at the same time and having different handheld receiving device, may act upon different hot spots and each get their relevant information.

Another aspect of the present invention is directed to providing interactive advertising that permits a viewer to order a product or service that is actually depicted in the video program. Instead of a news program, the viewer may be watching a comedy show having a scene where the actors and actresses are all sitting around talking and eating pizza. The viewer may press a button on their pointing device or remote control to highlight any hot spots that may be available for the particular scene. If the pizza box sitting on the coffee table became enhanced indicating it was a hot spot, a viewer may click or move the pointing device over the pizza box and thereby initiate ordering a pizza themselves, or request that a coupon be emailed, entitling the viewer to a reduced price for the pizza or other item advertised.

In still another aspect of the invention, rather than ordering a product or service by clicking on it in a scene, the viewer may also customize the advertising to be delivered during the periodic commercial breaks. With this approach, rather than having to view advertisements for unwanted products, the advertisements may be tailored to the viewer's interests and selections delivered during the commercial breaks.

Additionally, the present invention may be used in connection with political conventions or with any of the courtroom or ‘reality’ programming shows or the like, such that online polls could be established so that by selecting a candidate or participant during the convention or show, viewers could cast their vote for a particular candidate or participant in accord with what is being viewed.

In some embodiments, activating a hot spot may cause the screen to be changed into the traditional interactive enhancements with the reduced screen size and an L-shaped region with interactive content. Such an arrangement may be advantageous in some circumstances, such as when several options for a hot spot are available and the viewer is offered a menu of choices through the L-shaped region of the screen rather than have such choices be overlaid onto the video image.

In some embodiments, the viewer may have the option to turn off the hot spots from the display. The user may do this by selecting a button on the remote control, or the interactive content may be suppressed until the user makes a request for interactive content. An embodiment may begin showing an interactively enhanced television show and display a small icon in a specific area of the screen, indicating the presence of interactive content. The user would then use an interactive device, such as a remote control, to display the interactive elements on the screen and select one as desired. In other embodiments, the viewer may be charged a fee for having the hot spots active and allowing the viewer to enjoy the enhanced content. In other embodiments, the viewer may elect to pay a fee to have enhancements, for example, those advertising products, to be deactivated and not shown.

In other embodiments, the hot spot borders may illuminate briefly when the hot spot is activated then disappear from the screen. The viewer may still select the hot spot even though the hot spot is not visible on the screen. The cursor, for example, may change to indicate that the viewer has moved over a hot spot with interactive content. In some embodiments, when the viewer moves a cursor over a hot spot, called a mouseOver event, the hot spot border may illuminate or some other graphical representation. In some embodiments, a small text box may appear giving the name of the person in the hot spot or the description of the interactive content.

The shape of the hot spot may be used to more clearly identify what kind of information may be linked to the hot spot and may not be necessarily linked to a specific object on the screen. For example, a hot spot with a specific shape, such as a ‘Y’ or ‘N’ may be selected in response to a particular query, such as a confirmation of an order. The shape of the hot spot may correspond with a particular button on an input device. For example, the shape of hot spot 202 may be changed to an outline of the letter ‘A’, indicating that pressing the button labeled ‘A’ on an input device would activate that particular hot spot. In the example, an outline of a letter ‘A’ would be placed over the gentleman's face, maybe with a faint outline or other non-distracting method.

The hot spots may be completely transparent to the viewer and thereby cannot be seen by the viewer. In other embodiments, the hot spots may be shown as outlines, grayed out areas, different colored areas, hatched areas, a dim pulsating border, or other methods of showing the viewer that interactive content is available. In some embodiments, the hot spots may only become visible when the user places the cursor over the hot spot, also known as a mouseOver event. In some embodiments, the user may have the ability to turn on and off the display of the hot spots. For example, a viewer may elect to have the hot spots turned off so as not to distract from a video presentation. However, a small icon may be located in a corner or some other non-distracting position to indicate that interactive content is available. When the icon is available, the user may need to press a button or take some other action to make the hot spots visible.

The hot spot may be overlaid on top of the media so that an area of the screen does not have to be dedicated to displaying the availability of interactive content, which can be distracting to the enjoyment of the video presentation. Further, the hot spot does not have to even be seen by the viewer to be active and ready to present interactive content. In this manner, the viewer may fully enjoy the video presentation and still have all of the benefits of the interactive content. The viewer may move a cursor over the screen to find interactive content, or the viewer may have the ability to display the hot spot outlines on the screen on command. As the viewer becomes more familiar with the style and types of interactive content on a program, such as a broadcast football game, the viewer may not elect to have the hot spots illuminated and the viewer may be able to find the interactive content by hunting for the appropriate area of the screen for a hot spot.

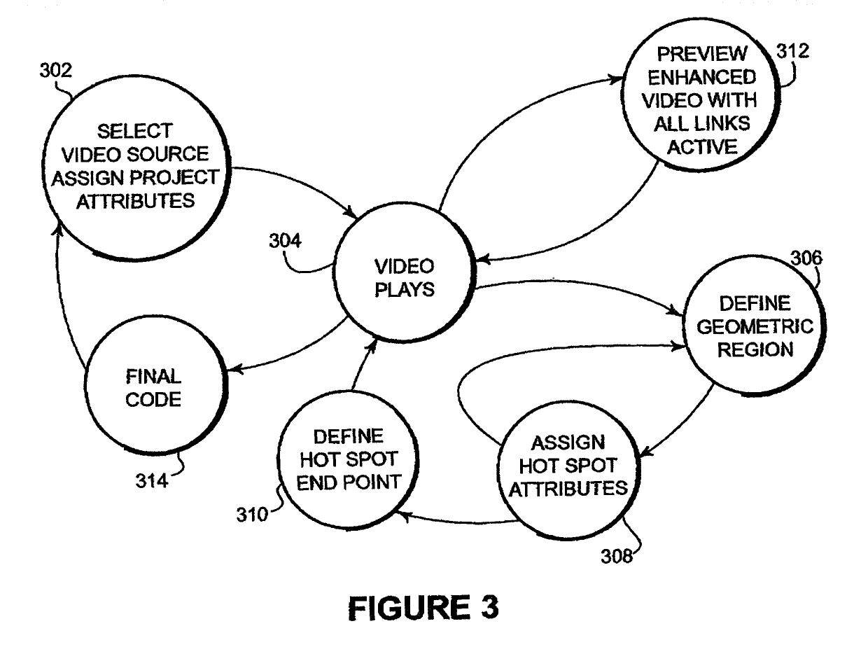

FIG. 3 illustrates a work flow diagram of an embodiment 300 of the present invention wherein a person (the ‘author’) may create and test hot spots interactively in a what you see is what you get (WYSIWYG) graphical user interface. The author selects the video source and assigns project related variables and attributes in block 302. The author may position and play the video image in block 304. When the author finds a region for a hot spot, the author hits pause and defines the geometric region on the screen in block 306. When the author releases the mouse, he is offered the opportunity to assign attributes to the hot spot in block 308. If another hot spot is to be created, the author has the ability to define additional hot spots at that point in the video by moving back to block 306. The author then positions the video to the place where the hot spot is to be removed and defines the end point in block 310. The author may play the video to another point and continue to add hot spots. Additionally, the author may wish to preview the video program with the enhancements activated in block 312. When the author is satisfied with the hot spots, the hot spots and attributes may be published into the final code in block 312. The author may begin a different video program in 302 and begin the cycle anew.

The selection of the video is done in block 302. Here, the author may assign attributes to the enhancement, such as any standardized styles or look and feel elements of the hot spots. Such styles may comprise a specific color, border width, or appearance elements that are common or default for the particular program being enhanced. In addition, defaults for behaviors of the hot spots may be defined, such as default links for the hot spots, how overlapping hot spots are to be treated, when the hot spots become illuminated, if at all, and other variables relating to the hot spot behavior. Other attributes may include the intended use of the video program, such as the specific set top box or set of set top boxes that may be used to display the program, the type of program being produced, information for interactive television guides, or other types of information.

The author may position and play the video in block 304. The author may jog the video quickly or slowly, forward or backward to select a precise frame of the video. The display for the video may have indications on the screen for the frame number or the time of the video from a time marker.

When the author finds the precise point for a hot spot, the author may pause the video and begin to define the hot spot in block 306. The author may create a geometric region for the hot spot directly on the screen, using a mouse or other pointing device. The author may create a rectangular, circular, or polygon shaped area for the hot spot. In addition, some embodiments may permit the author to define the hot spot using splines and curved sections. The author may be able to adjust and move vertices of the geometric areas to precisely move the lines or curves that define the hot spot.

The author may define attributes for the hot spot in block 308. The block 308 may be initiated immediately after the author releases a mouse button when the hot spot geometry is defined or the author may have to press another button when he is through manipulating the geometry. The attributes of the hot spot defined in block 308 may be variables associated with the action of the hot spot, such as a link to a specific web page or file, a textual description that will be displayed when the hot spot is activated, specific overrides of the default actions defined in block 302, or other action related variables. In addition, the attributes of the hot spot may relate to the presentation of the hot spot, such as color, border width, whether the hot spot is grayed out, pulsating borders, icons associated with the hot spot, or other visual attributes.

The author may elect to create another hot spot at the current point in the video program, and in so doing would return to block 306.

When the author has defined all of the hot spots at the current point of the video, the author may position and play the video to the end point of the hot spot in block 310. At this point, the author may define the end point of the hot spot. If the author has several hot spots that have defined start points but no end points, the author may be able to enter the current position as a stop point or may be able to position and play the video to another stop point for each hot spot where no stop point is defined.

After defining the hot spots, the author may preview the enhanced video with all of the hot spots active in block 312. The author may be able to view the video and actuate each hot spot and evaluate the correct performance of each hot spot. The author may be able to review and retry sections of the video to ensure that the author's enhancements are working correctly. If changes need to be made, the author may edit the hot spots using blocks 306, 308, and 310. The author may have provisions to position the video directly at the frame where a hot spot is first defined so that the author may make changes to the hot spot geometry and attributes. In addition, the author may be able to edit the project attributes from block 302 at any time during the operation of block 312.

When the author has completed the hot spot creation, the final results may be published into the final code of block 314. The final code may be created for one or more types of set top boxes.

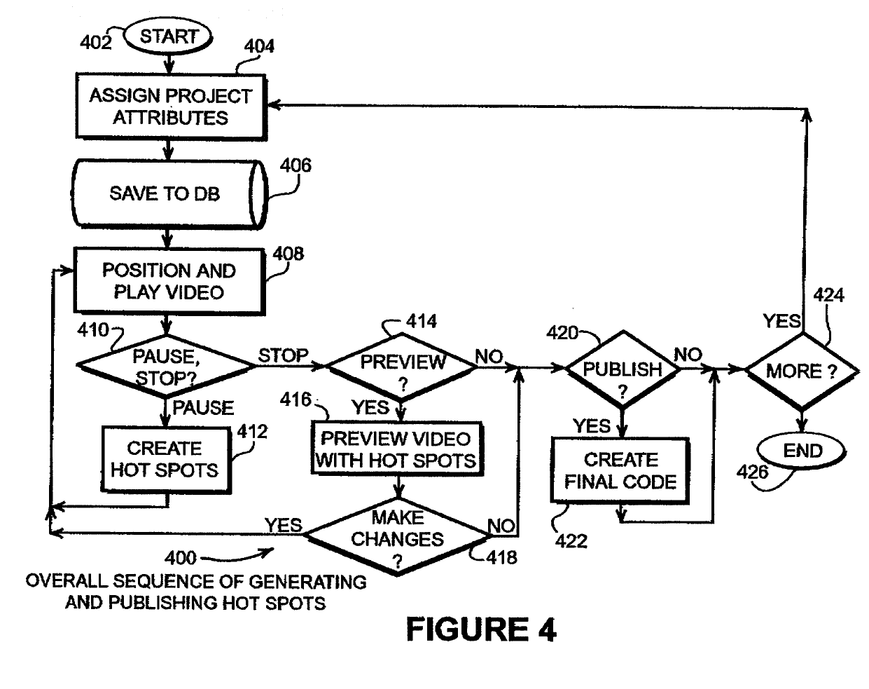

FIG. 4 is a flow chart of the overall sequence of an embodiment 400 of the present invention. The process starts in step 402. The project attributes are assigned in step 404 and saved to a database in step 406. The video is positioned and played in step 408 until the author pauses or stops in step 410. If the author pauses the video, he can create hot spots in step 412 on the frame at which he paused. If he stops the video, he has the option of previewing in step 414. If he previews in step 416, he has the option of making further changes in step 418. When he is satisfied with the preview, he has the option to publish in step 420, which creates the final code in step 422. The author then has the option of doing another video in step 424 or ending in step 426.

Embodiment 400 is a flow chart version of embodiment 300. The sequence of events shown in embodiment 400 is a typical use scenario of embodiment 300.

When the author assigns project attributes in step 404 and saves the attributes to a database in step 406, the author may be creating a file or database entry in any sort of language or file structure. The author is not cognizant of the data structure because the author only sees the graphical user interface on which he creates, edits, and views the hot spots. Throughout the discussion of embodiment 400, the references to the database may refer to any sort of data storage and retrieval scheme, including relational databases, a text file, XML, or any other scheme.

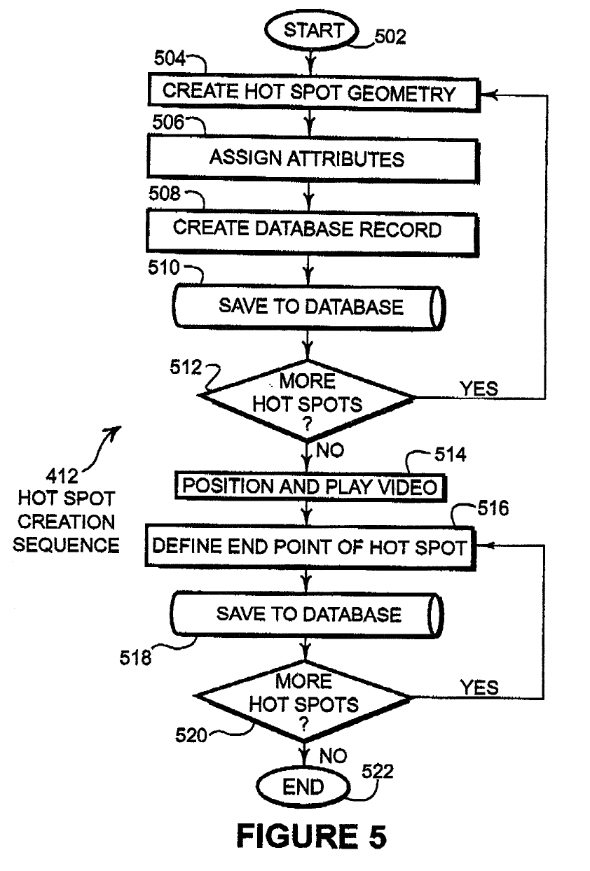

FIG. 5 is a flow chart of the sequence of step 412 of embodiment 400. The process starts in step 502, after the author has selected the frame at which to begin the hot spot. The geometry of the hot spot is created in step 504, the attributes assigned in step 506, and a database record is created in step 508 and saved in step 510. If additional hot spots are needed at this frame in step 512, the process is repeated. If no more hot spots are needed at this frame, the video is positioned in step 514 until the location of the end point of the hot spot is reached and is defined in step 516. The end point of the hot spot is saved in step 518. If there are still hot spots that need end points in step 520, the process is repeated. If not, the process ends in step 522.

The process 412 follows the process described in blocks 306, 308 and 310 of embodiment 300. Each hot spot may be created at a specific frame, attributes may be defined, then the video may be positioned to a second location where the hot spot is to be removed from the screen, and the second location may be saved. As the process is repeated for each hot spot, a database entry of each hot spot may be created.

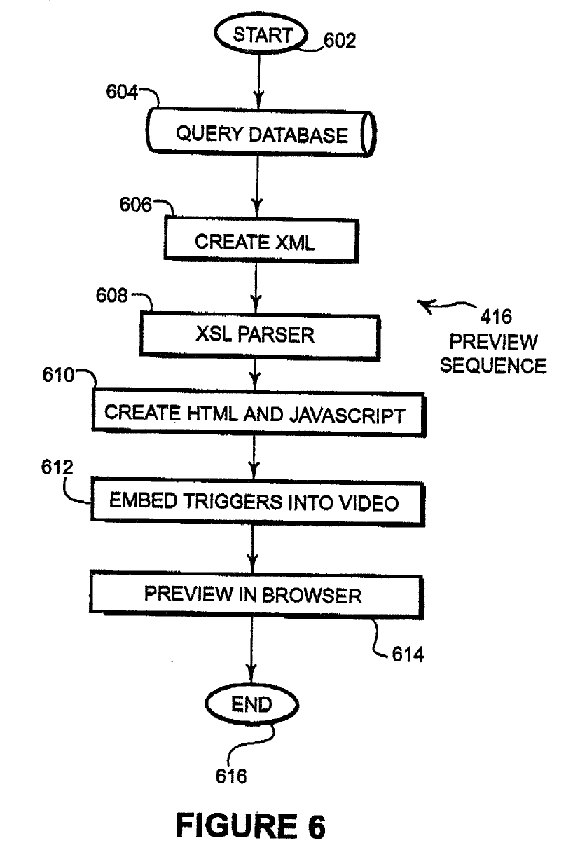

FIG. 6 is a flow chart of the sequence of step 416 of embodiment 400. The process starts in step 602, after the author has selected to preview the video with the hot spots activated. The database is queried in step 604 to retrieve the hot spot information and an XML database is created in step 606. An XSL parser in step 608 creates HTML and JavaScript code in step 610 that is embedded in step 612 or overlaid onto the video signal. The resultant video signal is previewed in a browser in step 614. The process ends in step 616.

The step 416 uses XML and an XSL parser to create an overlay that is combined with a video signal. Many other methods are available to those skilled in the art for taking the hot spot definitions, found in the database in step 604, and creating the hot spots, and displaying the hot spots with provisions so that the author may test the work he has completed. The example set forth here is exemplary in nature and is not meant to be restrictive in any sense.

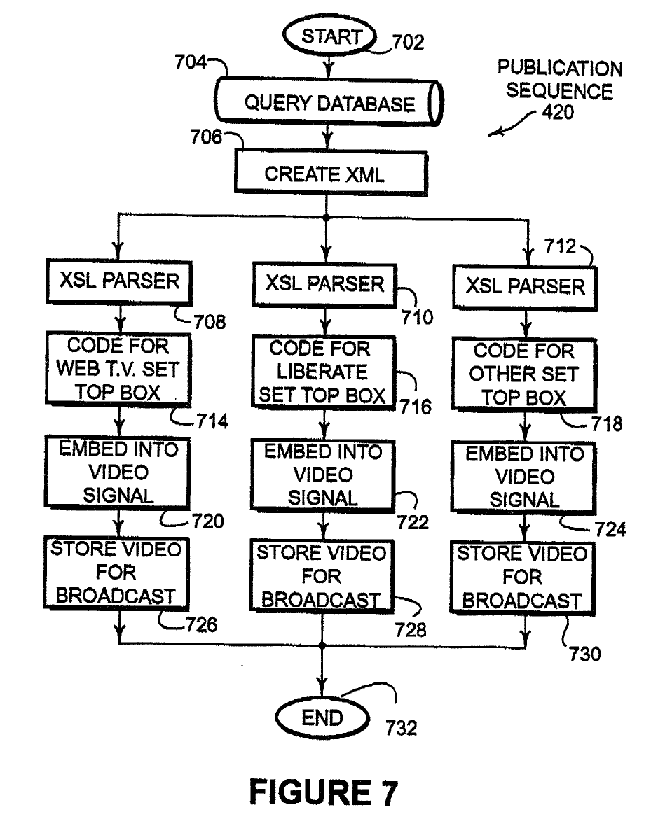

FIG. 7 is a flow chart of the sequence of step 420 of embodiment 400. The process starts in step 702, after the author has selected to publish the completed enhancements. The database is queried in step 704 to retrieve the hot spot information and an XML database is created in step 706. Several XSL parsers in steps 708, 710, and 712 create code for one or more of a WebTV set top box in step 714, a Liberate set top box in step 716, and other types of set top boxes in step 718. After the HTML and JavaScript code is created, the code is embedded into the video signal in steps 720, 722, and 724 and stored for broadcast in steps 726, 728, and 730. The process ends in step 732.

The step 420 uses XML and an XSL parser to create an overlay that is combined with a video signal. Many other methods are available to those skilled in the art for taking the hot spot definitions, found in the database in step 604, and creating the hot spots, and displaying the hot spots with provisions so that the author may test the work he has completed. The example set forth here is exemplary in nature and is not meant to be restrictive in any sense.

The step 420 may generate code that is specific to different set top boxes, but it also allows the author to create code that may be tailored in several other ways. For example, a specific XSL parser may create code that is language specific. In the case of a soccer game broadcast, an XSL parser may be used to generate code that is tailored for viewers from various countries, such as relating the URL links to a country's specific websites. The XSL parser may accomplish this by changing the URLs to a specific domain or path that is designated for a specific country, with those URLs being written in the home language of the intended audience. In other instances, the XSL parser may use a lookup table or other cross reference to change textual labels for the hot spots to another language. In another example, the attributes for the hot spots may include several links or other attributes that are set for specific languages and the XSL parser will only use the ones applicable for the specific language in which the video will be viewed.

In another example, an XSL parser may create code that has a specific style or behavior of hot spots for certain sets of viewers. In the case of broadcasts for those with disabilities, the hot spots may be larger, require only a mouseOver to operate, or have other parameters set to accommodate specific users. In some cases, certain broadcasters may wish to have a different look and feel of the interactive content. For example, a certain cable operator of a specific channel may want to have all of the interactive content shown in a certain color, whereas a broadcast network may wish to have a different color. In some cases, the first showing of a broadcast may have a certain set of links established for the interactive content and subsequent showings may have a different set of links.

The author may use a template to aid in creating interactive enhancements that have the same look and feel. The template may be an externally referenced document, which would allow the author to concentrate on generating the hot spots and links without having to concentrate on the look and feel of the hot spots. When the XSL parser is run, the template may be different for specific applications and result in a different look and feel of the interactive content. The templates may also have the ability to set a specific domain or path that would serve as a base for all links for the hot spots. The XSL parser, by changing the domain or path in the template, may thereby change the interactive links in a wholesale fashion without having to edit each link.

The HTML and JavaScript code may be embedded into the video signal by storing the code in the vertical blanking interval (VBI) of the video signal. Other methods may be employed to store the code in the video signal, depending on the type of set top box that is intended to display the video signal. Additionally, coding other than in HTML and JavaScript may be used depending on the type of set top box that receives the video signal. Further, multiple types of encoding and multiple types of code may be embedded into a single video signal so that multiple types of set top boxes may each take advantage of the enhanced video.

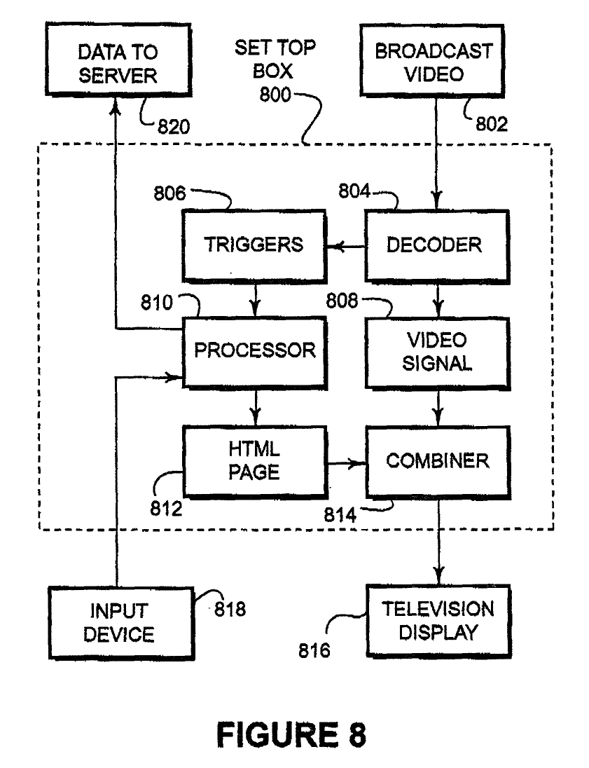

FIG. 8 illustrates a block diagram of a set top box 800. The broadcast video 802 enters the set top box and is parsed by the decoder 804 into the triggers 806 and the video signal 808. The processor 810 uses the trigger to create an HTML page 812 that is combined 814 with the video signal 808 to create a signal for the television display 816. An input device 818 generates a signal to the processor 810 which may generate data 820 that is sent back to a server.

The broadcast video 802 may be from any video source, such as an over the air broadcast, a cable television channel, a video tape, a DVD disk, or any other video source. It may be live or delayed in broadcast.

The decoder 804 takes the set top box commands or triggers 806 from the video signal 808. The decoder 804 may analyze the VBI of the video and remove commands, or it may evaluate other portions of the video signal for embedded commands, depending on the protocol used by the set top box and the system used to generate any interactive content.

The triggers 806 may include HTML and JavaScript commands and other commands and data that may be used by the processor 810. The commands may be of any language or standard and may not include HTML or JavaScript.

The processor 810 may be a general-purpose microprocessor or may be specially adapted to process specific commands, such as video image generation commands, quickly and efficiently.

The processor 810 may produce an HTML page 812 that is overlaid on the video signal 808 by combiner 814. The HTML page 812 may be a different type of mark up language, descriptor, or other method of defining the image and elements added to the video signal 808 to show the interactive content of the enhanced video broadcast. The combiner 814 may be a dedicated, specialized electronic hardware device in the set top box or may be a software routine executed by processor 810.

The input device 818 may be any device that generates a signal that can be interpreted by processor 810. Such a device may be a remote control, mouse, joystick, keyboard, hygrometer, pointing device, switch, audio input device, video input device, or any other device capable of providing a signal that can be interpreted by processor 810.

The processor 810 may take the signal from input device 818 and create data 820 that is sent to a server. The data may be expressly requested by the viewer to be transmitted such as a request for specific interactive content, communication regarding the purchase of a product, the input to a form requesting information, or other specific requests by the viewer. The data may also be transparent to the viewer, such as a log of the viewer's choices in television shows, any monitoring of the environment such as sensing the number of people viewing a program at one time, or other data that the user does not specifically request.

The set top box 800 may be a self contained electronic device that connects between the video source and the television 816 or the set top box 800 may be combined into another electronic device, such as the television, DVD player, video recorder, or other device.

The present invention simplifies and greatly increases the ability of producers of interactive television to create programming that may be seen on various hardware platforms. By creating the hot spot information in a generic form, various translators make it possible to generate hardware specific programming without any added work by the author or producer of the interactive program.

The concept of the translator may be extended to include performing translations for different languages, selecting different sets of links to which the hot spots refer, changing the look and feel of the interactive program, among other changes that can be performed by the translator.

The present invention allows an author to perform the manual operations of selecting the proper frames for a hot spot and generating the geometry of a hot spot with a minimum of extraneous work, such as entering attribute data for each hot spot. By using a template, the author only needs to enter the specific information that is unique to each hot spot, namely the geometry of the hot spot and the link to which it refers.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of creating links to enhanced content on a video stream comprising the steps of:
enabling a user to halt said video stream so at to provide a single video frame for viewing;
overlaying a portion of said single video frame with a geometric outline to identify a hot spot on said single video frame;
assigning enhancement attributes to said hot spot;
storing said hot spot and said attributes in a generic format;
translating said hot spot and said attributes from said generic format into a first format; and
embedding said hot spot and said attributes in said first format into a video stream.

2. The method of claim 1 further comprising the additional steps of:
translating said hot spot and said attributes from said generic format into a second format; and
embedding said hot spot and said attributes in said second format into a video stream.

3. The method of claim 1 wherein said translating is accomplished by an XSL translator.

4. The method of claim 2 wherein said first format is adapted to be displayed on a first set top box and said second format is adapted to be displayed on a second set top box.

5. The method of claim 2 wherein said first format comprises a first set of visual attributes and said second format comprises a second set of visual attributes, said first set of visual attributes and said second set of visual attributes having at least one dissimilar attribute.

6. The method of claim 2 wherein said first format comprises a first set of URL links and said second format comprises a second set of URL links, said first set of URL links and said second set of URL links having at least one dissimilar URL link.

7. The method of claim 2 wherein said first format is adapted to a first language and said second format is adapted to a second language.

8. A method of creating links to enhanced content on a video stream using a template comprising the steps of:
creating a template that defines at least one attribute for a hot spot;
enabling a user to halt said video stream so at to provide a single video frame for viewing;
overlaying a portion of said single video frame with a geometric outline to identify said hot spot on said single video frame;
assigning at least one attribute to said hot spot based on said template; and
embedding said hot spot and said attributes in said specific format into a video stream.

9. The method of claim 8 wherein said template comprises a visual attribute for a hot spot.

10. The method of claim 8 wherein said template comprises a language attribute for a hot spot.

11. The method of claim 8 wherein said template comprises a URL link attribute for a hot spot.

12. The method of claim 8 wherein said template comprises an attribute that determines the set top box used to display said hot spot.

13. A method of creating customized links to enhanced content on a video stream using a template comprising the steps of:
creating a template that defines at least one attribute for a hot spot;
enabling a user to halt said video stream so at to provide a single video frame for viewing;
overlaying a portion of said single video frame with a geometric outline to identify said hot spot on said single video frame;
assigning at least one attribute to said hot spot based on said template;
storing said hot spot and said attributes in a generic format;
translating said hot spot and said attributes from said generic format into a first format, said translating being done with said template; and
embedding said hot spot and said attributes in said first format into a video stream.

14. The method of claim 13 further comprising the steps of:
changing at least one attribute of said template;
translating said hot spot and said attributes from said generic format into a second format; and
embedding said hot spot and said attributes in said second format into a video stream.

15. The method of claim 13 wherein said translating is accomplished by an XSL translator.

16. The method of claim 14 wherein said first format is adapted to be displayed on a first set top box and said second format is adapted to be displayed on a second set top box.

17. The method of claim 14 wherein said first format comprises a first set of visual attributes and said second format comprises a second set of visual attributes, said first set of visual attributes and said second set of visual attributes having at least one dissimilar attribute.

18. The method of claim 14 wherein said first format comprises a first set of URL links and said second format comprises a second set of URL links, said first set of URL links and said second set of URL links having at least one dissimilar URL link.

19. A method of linking and using enhanced content on a video stream comprising the steps of:
enabling a user to halt said video stream so at to provide a single video frame for viewing;
overlaying a portion of said single video frame with a geometric outline to identify a hot spot on said single video frame;
assigning enhancement attributes to said hot spot;
storing said hot spot and said attributes in a generic format;
translating said hot spot and said attributes from said generic format into a first format;
embedding said hot spot and said attributes in said first format into a video stream;
displaying said hot spot using a first set top box on a video screen; and
allowing a viewer to access said hot spot whereby said viewer may access said enhanced content.

20. The method of claim 19 further comprising the additional steps of:
translating said hot spot and said attributes from said generic format into a second format;
embedding said hot spot and said attributes in said second format into a video stream;
displaying said hot spot using a second set top box on a video screen; and
allowing a viewer to access said hot spot whereby said viewer may access said enhanced content.

21. The method of claim 19 wherein said translating is accomplished by an XSL translator.

22. The method of claim 21 wherein said first set top box and said second set top box are different.

23. The method of claim 21 wherein said first format comprises a first set of visual attributes and said second format comprises a second set of visual attributes, said first set of visual attributes and said second set of visual attributes having at least one dissimilar attribute.

24. The method of claim 21 wherein said first format comprises a first set of URL links and said second format comprises a second set of URL links, said first set of URL links and said second set of URL links having at least one dissimilar URL link.

25. The method of claim 21 wherein said first format is adapted to a first language and said second format is adapted to a second language.
